(19) United States
(12) Patent Application Publication
(10) Pub. No.: US 2002/0180891 A1
(43) Pub. Date: Dec. 5, 2002

(54) System and method for preconditioning analog video signals

(75) Inventor: Lonnie D. Lindsey, Westminster, CA (US)

Correspondence Address: KING & SPALDING, 191 PEACHTREE STREET, N.E., ATLANTA, GA, 30303-1763, US

(73) Assignee: Cyber Operations, LLC, Jupiter, FL

(21) Appl. No.: 10/119,495

(22) Filed: Apr. 10, 2002

Related U.S. Application Data
(60) Provisional application No. 60/283,036, filed on Apr. 11, 2001.

(51) Int. Cl. H04N 5/213

(52) U.S. Cl. 348/608

(57) ABSTRACT

A composite analog video signal can be preconditioned by a preconditioning device that removes noise from the composite analog video signal. The preconditioning device can comprise a low-pass filter that removes noise from the composite analog video signal by passing frequencies of the composite analog video signal below about 6 MHz. A decoder can amplify the preconditioned composite analog video signal and can decode the amplified signal into digital component signals. A compression module can encode the digital component signals for transmission over a communication network. The compression module can encode to the digital component signals using an MPEG-1 or other compression standard.

### PRIORITY AND RELATED APPLICATIONS

This application claims the benefit of priority to U.S. Provisional Patent Application Ser. No. 60/283,036, entitled “Optimized Low Bit Rate Multimedia Content Network Delivery System,” filed Apr. 11, 2001. This application is related to U.S. Non-Provisional Patent Application of Ro, et al., entitled “System and Method for Network Delivery of Low Bit Rate Multimedia Content,” filed Apr. 10, 2002, and identified by Attorney Docket No. 08475.105001. The complete disclosure of each of the above-identified priority and related applications is fully incorporated herein by reference.

### FIELD OF THE INVENTION

The present invention relates generally to processing analog video signals for transmission on a communication network. More particularly, the present invention relates to filtering composite analog video input signals prior to amplifying those composite signals for decoding into component video signals and encoding at high compression ratios.

### BACKGROUND OF THE INVENTION

In today's network computing environment, people commonly transmit video signals over a narrow bandwidth communication network for viewing by others. The communication network typically comprises the Internet or a local area network. For video transmission over a network, analog video signals can be converted to digital video signals. Additionally, the digital video signals can be compressed prior to transmission over the network, thereby consuming less bandwidth to transmit those signals.

Noise associated with the video signals can reduce the quality of the video viewed by others and can increase the amount of bandwidth required to transmit the compressed video signal over the network. Video signal sources and the environment in which the video signals are produced and processed can add noise to the video signals. Conventional sources for providing an analog video signal include a video camera, a video cassette recorder (VCR), or a digital video disk (DVD) player. Each of those sources provides noise in its analog video signal. For example, a video camera includes an encoder that encodes the video signal into the National Television Standards Committee (NTSC) standard format. The encoder picks up electromagnetic interference (EMI) from surrounding electronic components. A video signal from a VCR includes similar noise. Additionally, a video signal from a VCR includes noise associated with the low quality of signal reproduction from the VCR tape.

Video signals also pick up noise while being transferred from the video source to a personal computer for transmission over a network. Typically, a composite video signal input is transmitted from an external video source through a multi-strand cable to an unshielded RCA connector at the personal computer. In that electronic environment of the personal computer, the video signal is subjected to high levels of EMI, AC/DC parasite capacitance, and radio frequency interference (RFI).

Additionally, in the case of low cost video encoder hardware applications using a personal computer (PC) interface form factor, the decoder and subsequent compression devices are housed within the computer. The RFI/EMI environment in which most personal computers operate can generate interference well above a normal professional video standard environment. With the added noise from less than perfect electrical systems, household appliances, and faulty PC power supplies, consumer grade encoding can include much higher levels of spurious noise than that found in a professional video environment. Accordingly, consumer grade video encoding devices provide a much lower video quality than that produced in a professional video environment.

A typical analog video signal comprises a composite video signal formed of Y, U, and V component video signals. The Y component of the composite video signal comprises the luminance component. The U and V components of the composite video signal comprise first and second color differences of the same signal, respectively. A decoding method can derive the YUV component signals from the original analog composite video signal.

Composite video signals are low voltage analog signals and are subject to a host of impairments caused by noise in the signal. Linear impairments such as cross talk, frequency error, ringing, and line/field time distortions can produce effects such as fuzzy edges, a blurred picture, streaking and smearing, and graininess. Non-linear impairments such as luminance non-linearity, chrominance to luminance cross talk, and differential gain distortion can produce effects such as changes in saturation with hue, improper changes in hue, and saturation with brightness. Amplitude errors like calibration errors, return loss, and sync to picture ratios can cause picture breakup and too dark or too light video.

The impairments discussed above are common to composite analog video signals. The consumer video to computer environment is particularly susceptible to those impairments due to the low cost video components, computer systems, and uncontrolled electrical environments in which those devices operate. Most of the impairments are inherent within the composite video standard and are present in more abundance with consumer grade devices where expensive signal conditioning is cost prohibitive.

With reference to FIG. 1, a conventional decoding device 100 for decoding a composite analog video signal into component analog video signals will be described. The conventional decoding device, or decoder, 100 converts a composite analog video signal into its Y, U, and V components. The decoder 100 depicted in FIG. 1 is illustrative of a Phillips Semiconductors decoder model number SAA 7113 H. As shown in FIG. 1, an analog video source 102 provides the composite analog video signal to the decoder 100. The analog video source can be a VCR, a video camera, or a DVD player. The analog video source 102 typically provides a one volt composite analog video signal.

In the decoder 100, an amplifier 104 receives the composite analog video signal from the analog video source 102 and amplifies that signal. In most video signal environments, the amplifier 104 compensates for power reductions due to the signal run lengths between the analog video source and the decoder 100. Typically, the amplifier 104 boosts the received composite analog video signal to about 3.3 volts. That amplification stage can boost the amplitude of the analog signal to allow more accurate signal processing by the decoder 100.

The amplifier 104 then outputs the amplified analog signal to an anti-alias filter 106. The anti-alias filter 106 attempts to average portions of the amplified signal to approximate the original signal. The anti-alias filter then outputs the signal to an analog to digital signal converter 108. The analog to digital signal converter 108 uses digital processing and converts the analog composite video signal to a digital composite video signal, digitally filters noise from the digital composite video signal, and derives the Y, U, and V component signals from the digital composite signal. The converter 108 then outputs the Y, U, and V digital component signals from the decoder 100 to a compression module 110. The compression module 110 can compress (encode) the digital composite signals for transmission over the communication network. The compression module 110 can process the component signals by either a software only encoding method or by a combination hardware/software encoding method.

The conventional methods and devices discussed above suffer from several problems. For example, conventional methods amplify the incoming composite analog signal before the decoding process without regard to whether the incoming signal includes any noise or impairments. Accordingly, any noise associated with the input analog signal is also amplified, further reducing the quality of the input composite analog signal. The analog to digital signal converter also converts the amplified analog noise to digital noise, thereby reducing the quality of the component digital signals. Even though the digitized signal is digitally filtered to reduce noise, the amplifier can boost the noise in the analog signal beyond the capability of the digital filtering. Furthermore, when the video signal is compressed, the entire signal is processed without regard to whether the signal contains impairments or noise. The noise is compressed along with the signal, thereby increasing the amount of bandwidth required to transmit the compressed signal over the network.

Conventional methods also do not account for the lower quality of the input analog signal. Most decoders and subsequent compression devices assume a professional environment from which the video signal is derived. While professional state of the art digital processing removes a certain amount of noise from the video signal, that method is tailored for operating on professional grade video signals. Professional grade component video signals include less noise than consumer grade component video signals. Accordingly, using those professional decoding methods on a consumer grade composite video signal results in a lower quality signal. The design of consumer grade devices cannot fully anticipate the breadth of noise generation from all possible sources and remove all the impairments without implementing several more stages of digital filtering. Those additional stages of digital filtering are cost prohibitive in the consumer market and are typically reserved for the professional market.

Therefore, a need in the art exists for a system and method that can provide a cleaner input composite video signal prior to the amplifier stage of the decoder. The cleaner input composite video signal can improve the over all performance of the decoder and subsequent compression methods. A need in the art also exists for a low cost, integrated filtering system and device that can precondition the composite analog video signal prior to decoding and low bit rate compression of the signal for transmission over a communication network.

### SUMMARY OF THE INVENTION

The present invention can provide a system and method for preconditioning a composite analog video signal prior to amplifying that signal for decoding. Preconditioning the signal can remove spurious noise associated with the signal, providing a cleaner input signal for the decoding process. The preconditioned, cleaner signal can increase the performance of decoding and compression techniques. For example, the preconditioned signal can contain less noise that is amplified during decoding, increasing the quality of decoded signals. Additionally, the higher quality decoded signals can contain less noise, decreasing the amount of bandwidth necessary to transmit those signals over a communication network.

The present invention can comprise a filtering device employed between a composite analog video source and an amplifier stage of a decoder. The filtering device can comprise a low-pass filter. The low-pass filter can comprise a seven-pole (seven-stage) anti-alias low-pass filter. The filtering device can comprise resisters and capacitors arranged in a circuit to receive continuous lines of composite analog video signals, perform anti-aliasing of the analog signals, and allow a pass through of predetermined frequencies. The predetermined frequencies can be below 6 MHz. The filtering device can direct noise present in the video signal to ground. The signal output from the filtering device can be output to the amplifier stage of a decoder.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a block diagram depicting a conventional decoding device for decoding a composite analog video signal into component analog video signals.

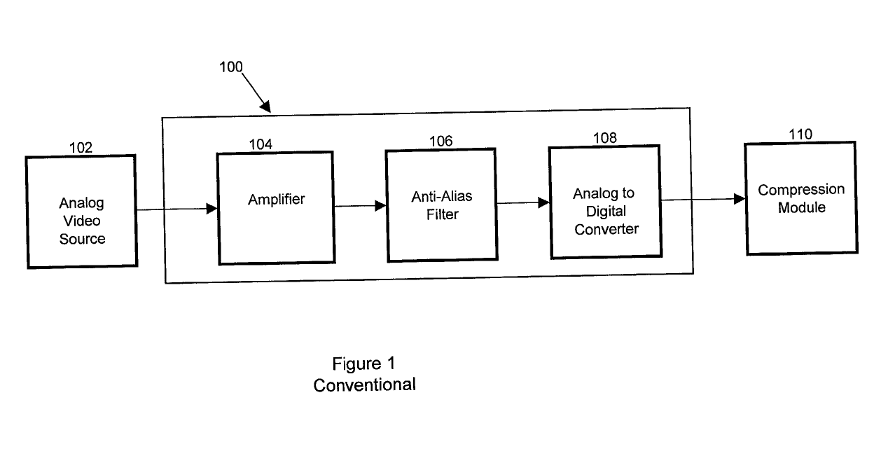

FIG. 2 is a block diagram depicting a system for preconditioning composite analog video signals according to an exemplary embodiment of the present invention.

FIG. 3 is a circuit diagram illustrating a device for preconditioning composite analog video signals according to an exemplary embodiment of the present invention.

FIG. 4 is a flow chart depicting a method for preconditioning composite analog video signals according to an exemplary embodiment of the present invention.

### DETAILED DESCRIPTION OF EXEMPLARY EMBODIMENTS

The present invention can provide a system and method for preconditioning a composite analog video signal prior to amplifying that signal for decoding. Preconditioning the signal can remove spurious noise associated with the signal, providing a cleaner input signal for the decoding process. The preconditioned, cleaner signal can increase the performance of decoding and compression techniques.

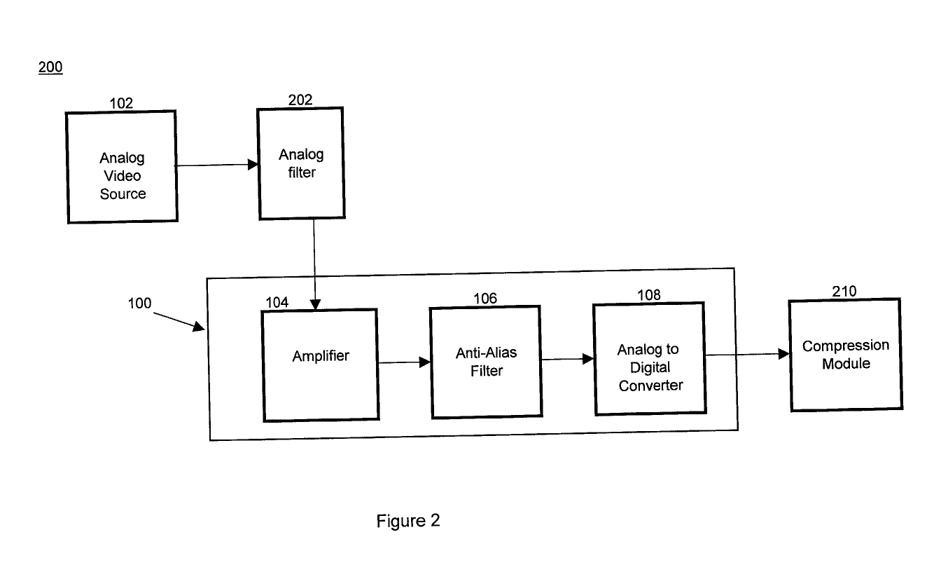

Exemplary embodiments of the present invention will be described below with reference to FIGS. 2-4 in which the same reference numerals represent similar elements.

Referring to FIG. 2, a system 200 for preconditioning composite analog video signals according to an exemplary embodiment of the present invention will be described. As shown, the system 200 can comprise an analog video source 102 that provides a composite analog video signal to a preconditioning device 202. For example, the analog video source can comprise a VCR, a video camera, or a DVD player. The preconditioning device 202 can filter the composite analog video signal and can remove spurious noise prior to sending the signal to the decoder 100. If the decoder 100 can process more than one input signal, then additional preconditioning devices 202 (not shown) can be provided for each input signal. The decoder 100 can convert the composite analog video signal into digital signals of its Y, U, and V components.

In the decoder 100, the amplifier 104 receives the preconditioned composite analog video signal from the preconditioning device 202 and amplifies that signal. Typically, the amplifier 104 boosts the received composite analog video signal to about 3.3 volts. The amplifier 104 outputs the amplified analog signal to the anti-alias filter 106. The anti-alias filter 106 attempts to average portions of the amplified signal to approximate the original signal received by the amplifier 104. The anti-alias filter then outputs the signal to the analog to digital signal converter 108.

The analog to digital signal converter 108 uses digital processing and can convert the analog composite video signal to a digital composite video signal, digitally filter noise from the digital composite video signal, and derive the Y, U, and V component signals from the digital composite signal. The converter 108 then outputs the Y, U, and V digital component signals from decoder 100 to a compression module 210. The compression module 210 can compress (encode) the digital composite signals for transmission over a communication network. The compression module 210 can process the component signals by either a software only encoding method or by a combination hardware/software encoding method.

Compression module 210 can use various standards for compressing the video signals for transmission over a network. For example, International Standard ISO/IEC 11172-2 (Video) describes the coding of moving pictures into a compressed format. That standard is more commonly known as Moving Pictures Expert Group 1 (MPEG-1) and allows for the encoding of moving pictures at very high compression rates. Alternative standards include MPEG 2, 4, 5, and 7. Other standards are not beyond the scope of the present invention. The compression module can operate as described in related U.S. Non-Provisional Patent Application of Ro, et al., entitled “System and Method for Low Bit Rate Multimedia Content Network Delivery” filed Apr. 10, 2002. Alternatively, a conventional compression module can be used to perform the encoding.

As stated above, the preconditioning device 202 can remove spurious noise from the composite analog signal before that signal is transmitted to the decoder 100. Accordingly, the preconditioned analog signal provided from the preconditioning device 202 to the decoder 100 can contain less noise than a conventional composite analog signal. Thus, the amplifier 104 of the decoder 100 can amplify less noise than in conventional systems, increasing the quality of decoded signals. The amplifier 104 does not amplify the impairments removed by the preconditioning device 202 as it amplifies the signal amplitude. With less impairments to improve, the decoder 100 can consistently improve upon any remaining impairments contained within the analog video signal. Accordingly, the system 200 can result in a 20% reduction in the incidence of impairments in the processed video signals.

Additionally, the higher quality decoded signals can contain less noise. Because the decoded signal comprises less noise, the compressed signal produced by the compression module 210 for transmission over the network can be smaller than conventional compressed signals. Accordingly, the smaller size of those compressed signals can decrease the amount of bandwidth necessary to transmit those signals over the communication network. Thus, the system 200 can provide a higher quality video signal at a higher compression ratio. Additionally, the higher quality video signal can produce a higher quality video image for any compression ratio.

The present invention is not limited to the architecture described with reference to FIG. 2. For example, the preconditioning device 202 can be provided as part of the decoder 100, rather than as a separate component. In that exemplary embodiment, the preconditioning device 202 can be provided as part of the decoder 100 prior to the amplifier 104. Other configurations are not beyond the scope of the present invention.

According to an exemplary embodiment of the present invention, the preconditioning device can comprise a low-pass filter. The preconditioning device can comprise resisters and capacitors arranged in a circuit to receive continuous lines of composite analog video signals, to perform anti-aliasing of the analog signals, and to allow a pass through of predetermined frequencies. The predetermined frequencies can be frequencies below about 10 MHz, below about 6 MHz, and below about 4.5 MHz. The predetermined frequencies also can be any frequency below a frequency in the range of about 4.5 MHz to about 10 MHz. The preconditioning device can direct noise present in the video signal to ground and can output a preconditioned signal to the amplifier stage of the decoder.

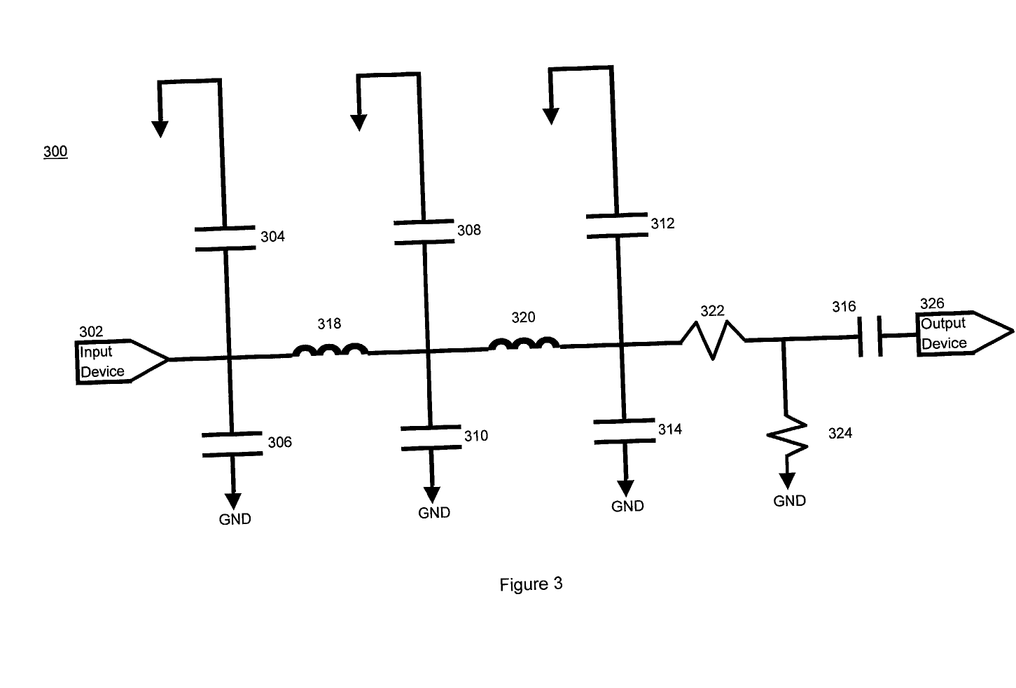

Referring to FIG. 3, a preconditioning device 300 for preconditioning composite analog video signals according to an exemplary embodiment of the present invention will be described. As shown in FIG. 3, the preconditioning device 300 can comprise a seven-pole (seven stage), anti-alias, low-pass filter. The preconditioning device 300 can comprise an input device 302 for receiving a composite analog video signal and an output device 304 for outputting a preconditioned composite analog video signal. The preconditioning device 300 also can comprise capacitors 304-316, inductors 318, 320, and resistors 322, 324.

The capacitors 304-316 can be coupled with the inductors 318, 320 or the resistors 322, 324 to produce bandwidth traps. Each bandwidth trap can capture noise in a predetermined frequency range and can send the captured noise to ground. The remaining signal can pass through to the next bandwidth trap or to the output device 326. For example, capacitor 304 can be coupled to inductor 318 to produce a first bandwidth trap. Capacitor 306 can be coupled to inductor 318 to produce a second bandwidth trap. Capacitor 308 can be coupled to inductor 320 to produce a third bandwidth trap. Capacitor 310 can be coupled to inductor 320 to produce a fourth bandwidth trap. Capacitor 312 can be coupled to resistor 322 to produce a fifth bandwidth trap. Capacitor 314 can be coupled to resistor 322 to produce a sixth bandwidth trap. Capacitor 316 can be coupled to resistor 324 to produce a seventh bandwidth trap.

the present invention is not limited to the number of capacitors, inductors, or resistors, or the number of resulting bandwidth traps, produced in the exemplary embodiment depicted in FIG. 3. Rather, preconditioning devices having more or less components that filter noise from the composite analog video signal prior to amplification are not beyond the scope of the present invention.

In one exemplary embodiment of the present invention, the characteristics of each component shown in FIG. 3 can be as identified below in Table I.

TABLE I

| Component | Value |
|---|---|
| 304 | 56 pico-Farads (pF) |
| 306 | 82 pF |
| 308 | 180 pF |
| 310 | 180 pF |
| 312 | 56 pF |
| 314 | 82 pF |
| 316 | 0.1 pF |
| 318 | 1.8 micro-Henrys (μH) |
| 320 | 1.8 μH |
| 322 | 27 ohms (Ω) |
| 324 | 47 Ω |

The preconditioning device 300 configured as shown in Table I can smooth the composite analog video signal's sine wave to remove aliased elements to ground while rounding off the frequency bandwidth to about 3 dB down at 6 MHz. Since impairments are typically present most in frequencies above 6 MHz, impairments manifested by higher frequency aliasing of the sine wave can be negated.

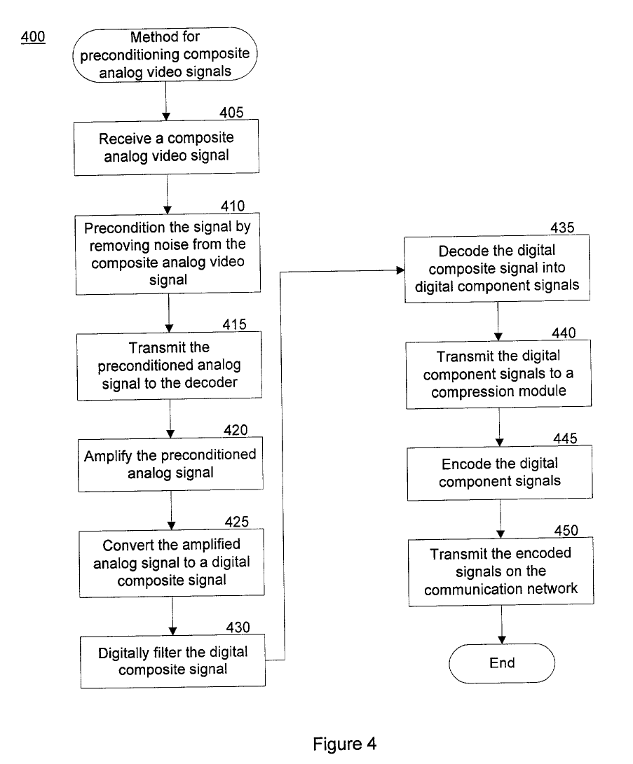

Referring to FIG. 4, a method 400 for preconditioning composite analog video signals according to an exemplary embodiment of the present invention will be described. In step 405, a preconditioning device can receive a composite analog video signal. In Step 410, the preconditioning device can precondition the signal by removing noise from the composite analog video signal. Then in step 415, the preconditioning device can transmit the preconditioned analog signal to a decoder. The preconditioning device can be as described above with reference to FIGS. 2 and 3.

The decoder can amplify the preconditioned analog signal (step 420), convert the amplified analog signal to a digital composite signal (step 425), and digitally filter the digital composite signal to reduce noise contained therein (step 430). Then in step 435, the decoder can decode the digital composite signal into its digital component signals. The decoder can then transmit the digital component signals to a compression module in step 440.

In step 445, the compression module can encode the digital component signals. The compression module can operate as described in related U.S. Non-Provisional Patent Application of Ro, et al., entitled “System and Method for Network Delivery of Low Bit Rate Multimedia Content,” filed Apr. 10, 2002, and identified by Attorney Docket No. 08475.105001. Alternatively, a conventional compression module can be used to perform the encoding step. In step 450, the encoded signals can be transmitted on the communication network.

Although specific embodiments of the present invention have been described above in detail, the description is merely for purposes of illustration. Various modifications of, and equivalent steps corresponding to, the disclosed aspects of the exemplary embodiments, in addition to those described above, can be made by those skilled in the art without departing from the spirit and scope of the present invention defined in the following claims, the scope of which is to be accorded the broadest interpretation so as to encompass such modifications and equivalent structures.

What is claimed is:

1. A system for preconditioning a composite analog video signal, comprising:
a preconditioning device that produces a preconditioned composite analog video signal by removing noise from the composite analog video signal; and
a decoder that produces digital component signals by amplifying the preconditioned signal to produce an amplified composite analog video signal and then decoding the amplified signal into the digital component signals.

2. The system according to claim 1, wherein said preconditioning device removes noise by smoothing a sine wave associated with the composite analog video signal.

3. The system according to claim 1, wherein said preconditioning device comprises a low-pass filter that removes noise from the composite analog video signal by passing frequencies of the composite analog video signal below about 6 MHz.

4. The system according to claim 3, wherein said low-pass filter comprises a filter circuit having a plurality of bandwidth traps, each bandwidth trap removing noise within a predetermined frequency range from the composite analog video signal.

5. The system according to claim 4, wherein one of said bandwidth traps comprises a grounded capacitor stage.

6. The system according to claim 4, wherein said filter circuit comprises seven bandwidth traps, and
wherein each of said bandwidth traps comprises a grounded capacitor stage.

7. The system according to claim 1, further comprising a compression module that encodes the digital component signals for transmission over a communication network.

8. The system according to claim 7, wherein said compression module encodes the digital component signals using an MPEG-1 compression standard.

9. The system according to claim 7, further comprising an analog video source that provides the composite analog video signal to said preconditioning device.

10. A method for preconditioning composite analog video signals, comprising the steps of:
receiving a composite analog video signal;
preconditioning the composite analog video signal by removing noise from the composite analog video signal;
amplifying the preconditioned composite analog video signal to provide an amplified composite analog video signal; and
decoding the amplified composite analog video signal into digital component signals.

11. The method according to claim 10, further comprising the step of encoding the digital component signals for transmission over a communication network.

12. The method according to claim 11, wherein said encoding step comprises encoding the digital component signals using an MPEG-1 compression standard.

13. The method according to claim 10, wherein said preconditioning step comprises removing noise from the composite analog video signal by passing frequencies of the composite analog video signal below a predetermined frequency.

14. The method according to claim 13, wherein said preconditioning step comprises removing noise from the composite analog video signal by passing frequencies of the composite analog video signal below about 10 MHz.

15. The method according to claim 13, wherein said preconditioning step comprises removing noise from the composite analog video signal by passing frequencies of the composite analog video signal below about 6 MHz.
